(19) United States
(12) Patent Application Publication
(10) Pub. No.: US 2001/0018485 A1
(43) Pub. Date: Aug. 30, 2001

(54) WELDABLE RESIN COMPOSITION PRODUCTION THEREOF, AND MOLDED PRODUCT

(76) Inventors: HIDEO MATSUOKA, NAGOYA (JP); SHIGERU OKITA, KAWASAKI (JP)

Correspondence Address: MILLER & CHRITENBURY PC, SUITE 3600, 1600 MARKET STREET, PHILADELPHIA, PA, 191037286

(21) Appl. No.: 09/427,311

(22) Filed: Oct. 26, 1999

(30) Foreign Application Priority Data
Oct. 26, 1998 (JP) 10-304544
Apr. 28, 1998 (JP) 11-121897

(51) Int. Cl. C08K 3/34; C08L 1/00

(52) U.S. Cl. 524/492; 524/588

(57) ABSTRACT

A weldable resin composition which comprises 100 parts by weight of nylon resin as component (A), 0.1-50 parts by weight of polyolefin resin as component (B), 10-150 parts by weight of glass fiber as component (C), 0-3 parts by weight of copper compound as component (D), and 0-5 parts by weight of silicone compound as component (E). A molded product produced from the weldable resin composition by welding (such as vibration welding).

### BACKGROUND OF THE INVENTION

1. Field of the Invention

The present invention relates to a weldable resin composition which gives molded items superior in heat resistance, external appearance, dimensional stability, and uniform weldability. More particularly, the present invention relates to a weldable resin composition, a process for production thereof, and a molded item thereof, said resin composition being suitable for production of a hollow object by welding from two or more melt-molded items.

2. Description of the Related Arts

Nylon resin is widely used for automobiles and machine parts on account of its good moldability, heat resistance, toughness, oil and gasoline resistance, and wear resistance. The development of nylon resin in this field has been motivated mainly by substitution for metallic materials. Substitution actually proceeded from those parts in which nylon resin brings out its merit, such as weight reduction and corrosion prevention. With recent improvement in material performance and molding technology, nylon resin has reached a stage at which studies are made on its application to large complicated parts whose substitution has been considered difficult.

Making such parts from nylon resin needs not only individual molding technologies (such as injection molding, extrusion molding, and blow molding) but also post-processing technologies (such as cutting, bonding, and welding) in combination. Unfortunately, conventional nylon resin compositions are formulated without post-processing being taken into account. If two or more parts of glass-reinforced nylon resin are to be welded together (by vibration welding or injection welding) to form a composite part of desired shape, it is difficult to achieve the desired level of strength in the weld zone. This is true particularly with large parts. Thus the use of nylon resin has been limited.

### SUMMARY OF THE INVENTION

It is the first object of the present invention to provide a weldable nylon resin composition which gives molded items without posing a problem of weld strength.

It is the second object of the present invention to provide a weldable nylon resin composition for production of molded items with intricately curved welding surfaces. This resin composition invariably ensures high weld strength.

It is the third object of the present invention to provide a weldable nylon resin composition which yields molded items with high weld strength while retaining nylon's inherent characteristics such as good moldability, heat resistance, toughness, oil and gasoline resistance, wear resistance, and surface smoothness.

The first aspect of the present invention is embodied in a weldable resin composition which comprises 100 parts by weight of nylon resin as component (A), 0.1-50 parts by weight of polyolefin resin as component (B), and 10-150 parts by weight of glass fiber as component (C) blended together.

The second aspect of the present invention is embodied in a process for producing a weldable resin composition, said process comprising melt-blending together 100 parts by weight of nylon resin as component (A), 0.1-50 parts by weight of polyolefin resin as component (B), 10-150 parts by weight of glass fiber as component (C), 0-3 parts by weight of copper compound as component (D), and 0-5 parts by weight of silicone compound as component (E). This embodiment may be modified such that the components (A), (C), (D), and (E) are melt-blended together and the resulting composition is subsequently incorporated with the component (B).

Additional embodiments of the present invention include a molded item made of said weldable resin composition, a method of producing a molded product by welding from more than one molded item made of said weldable resin composition, and a molded product produced by said method.

### BRIEF DESCRIPTION OF THE DRAWINGS

FIG. 1 is a diagram showing the shape of a test piece used to evaluate the strength of vibration welding in the example. Parts A, B, C, and D are a plan view, a front view, a right side view, and a bottom view, respectively.

FIG. 2 is a diagram showing the shape of another test piece used to evaluate the strength of vibration welding in the example. Parts A, B, and C are a plan view, a front view, and a right side view, respectively.

FIG. 3 is a diagram showing the shape of a hollow molded product obtained by vibration welding from the test pieces each shown in FIG. 1 and FIG. 2. Parts A, B, and C are a plan view, a front view, and a right side view, respectively.

FIG. 4 is a plan view showing the shape of a test piece used to evaluate the strength of injection welding in the example.

FIG. 5 is a plan view showing the shape of a molded product formed from the test pieces shown in FIG. 4, which was used to evaluate the strength of injection welding in the example.

### DESCRIPTION OF THE PREFERRED EMBODIMENTS

In the following description, “weight” means “mass”. The term “welding” as used in the present invention implies a process of melting the contact surfaces of more than one molded item such that the molten surfaces bond together. Welding may be accomplished by, for example, vibration welding, ultrasonic welding, spin welding, injection welding, microwave welding (RF induction welding), hot plate welding, or hot air welding. Of these welding methods, vibration welding, injection welding (with the die sliding or rotating), ultrasonic welding, and microwave welding are desirable. Among them vibration welding is the most desirable because of its good balance between high strength and easy processing.

Component (A) used in the present invention is a nylon resin, which is a polyamide composed mainly of dicarboxylic acid and any of amino acid, lactam, and diamine.

Typical examples of the major constituents are listed below.

Amino acid such as 6-aminocaproic acid, 11-aminoundecanoic acid, 12-aminododecanoic acid, and p-aminomethyl benzoic acid.

Lactam such as s-caprolactam and o-laurolactam.

Aliphatic, alicyclic, and aromatic diamines, such as tetramethylenediamine, hexamethylenediamine, 2-methylpentamethylenediamine, nonamethylenediamine, undecamethylenediamine, dodecamethylenediamine, 2,2,4- and/or 2,4,4,-trimethylhexamethylenediamine, 5-methylnonamethylenediamine, m-xylylenediamine, p-xylylenediamine, 1,3-bis(aminomethyl)cyclohexane, 1,4-bis(aminomethyl)cyclohexane, 1-amino-3-aminomethyl-3,5,5-trimethylcyclohexane, bis(4-aminocyclohexyl)methane, bis(3-methyl-4-aminocyclohexyl)methane, 2,2-bis(4-aminocyclohexyl)propane, bis(aminopropyl)piperazine, and aminoethylpiperazine.

Aliphatic, alicyclic, and aromatic dicarboxylic acids, such as adipic acid, suberic acid, azelaic acid, sebacic acid, dodecanoic acid, terephthalic acid, isophthalic acid, 2-chloroterephthalic acid, 2-methylterephthalic acid, 5-methylisophthalic acid, 5-sodium sulfoisophthalic acid, hexahydroterephthalic acid, and hexahydroisophthalic acid.

The nylon resin used in the present invention may be a homopolymer or copolymer produced from these raw materials. Such polymers may be used alone or in combination with one another.

The nylon resin used in the present invention should preferably be one which has a melting point higher than 200° C. so that it has good heat resistance and high strength. Typical examples of the nylon resin are listed below. Polycaproamide (nylon 6), polyhexamethylene adipamide (nylon 66), polycaproamide/polyhexamethylene adipamide copolymer (nylon 6/66), polytetramethylene adipamide (nylon 46), polyhexamethylene sebacamide (nylon 610), polyhexamethylene dodecamide (nylon 612), polyhexamethylene terephthalamide/polycaproamide copolymer (nylon 6T/6), polyhexamethylene adipamide/polyhexamethylene terephthalamide copolymer (nylon 66/6T), polyhexamethylene adipamide/polyhexamethylene isophthalamide copolymer (nylon 66/6I), polyhexamethylene adipamide/polyhexamethylene terephthalamide/polyhexamethylene isophthalamide copolymer (nylon 66/6T/6I), polyhexamethylene terephthalamide/polyhexamethylene isophthalamide copolymer (nylon 6T/6I), polyhexamethylene terephthalamide/polydodecaneamide copolymer (nylon 6T/12), polyhexamethylene terephthalamide/ poly(2-methylpentamethylene)terephthalamide copolymer (nylon 6T/M5T), polyxylylene adipamide (nylon XD6), and polynonamethylene terephthalamide (nylon 9T). They may be used in the form of blend or copolymer.

Preferable among these examples are nylon 6, nylon 66, nylon 6/66 copolymer, copolymer nylon composed mainly of nylon 6 or nylon 66, nylon 610, and copolymers (such as nylon 6T/66 copolymer, nylon 6T/6I copolymer, and nylon 6T/6 copolymer) having hexamethylene terephthalamide units. Nylon 6, nylon 66, and copolymers thereof are most desirable.

It may be used two or more kinds of these nylon resins so as to improve their characteristic properties, such as moldability, heat resistance, and weldability. A desirable composition would consist of 99-50 wt % of component (a) and 1-50 wt % (preferably 15-30 wt %) of component (b), where component (a) is at least one kind of nylon resin selected from nylon 66, nylon 6, and nylon copolymer composed mainly of them, and component (b) is at least one kind of nylon resin other than mentioned above (selected from higher nylons such as nylon 610 and nylon 612, and semiaromatic nylons such as nylon 6T/6, nylon 6T/12, nylon 6T/66, nylon 66/6I, nylon 66/6T/6I, nylon 6T/6I, and nylon 6T/M5T). Such a composition is desirable from the standpoint of improved weldability.

These nylon resins are not specifically restricted in the degree of polymerization. Those which have a relative viscosity of 1.5-5.0, particularly 2.0-4.0, are desirable. (Measured for 1% solution in 98% conc. sulfuric acid at 25° C.)

Component (B) used in the present invention is a polyolefin resin, which has a polyolefin skeleton in the main chain. It is not specifically restricted so long as it adequately controls the melt viscosity of the resulting resin composition. For example, it may be a crystalline one or an amorphous one or a composition thereof. It may be a homopolymer of unsaturated monomer or a copolymer of more than one monomer or a composition thereof. The copolymer may be a random copolymer or a block copolymer or a composition thereof.

Examples of the polyolefin rein as component (B) are listed below.

Homopolymers such as polyethylene, polypropylene, polystyrene, polyacrylate ester, polymethacrylate ester, poly-1-butene, poly-1-pentene, and polymethylpentene.

Ethylene-α-olefin copolymer.

Homopolymer of vinyl alcohol ester.

Polymer obtained by partial or whole hydrolysis of homopolymer of vinyl alcohol ester. [polymer obtained by partial or whole hydrolysis of copolymer of (ethylene and/or propylene) and vinyl alcohol ester].

Copolymer of (ethylene and/or propylene) and (unsaturated carboxylic acid and/or unsaturated carboxylic ester), such as copolymer of ethylene and (meth)acrylic acid and copolymer of ethylene, (meth)acrylic acid, and (meth)acrylic ester.

Copolymer of (ethylene and/or propylene) and (unsaturated carboxylic acid and/or unsaturated carboxylic ester), with its carboxylic groups at least partly neutralized to form metal salt, such as ethylene- (meth) acrylic acid copolymer, with its carboxylic groups at least partly neutralized to form metal salt, and ethylene- (meth) acrylic acid- (meth) acrylic ester copolymer, with its carboxylic groups at least partly neutralized to form metal salt.

Block copolymer of conjugated diene and vinyl aromatic hydrocarbon.

Hydrogenated product of said block copolymer.

Preferable among these examples are polyethylene, polypropylene, polyacrylate ester, polymethacrylate ester, ethylene-α-olefin copolymer, a copolymer of (ethylene and/or propylene) and (unsaturated carboxylic acid and/or unsaturated carboxylic ester), with its carboxylic groups at least partly neutralized to form metal salt, block copolymer of conjugated diene and vinyl aromatic hydrocarbon, and hydrogenated product of said block copolymer. Polyethylene and ethylene-α-olefin copolymer are particularly desirable.

The ethylene-α-olefin copolymer should preferably be one which is composed of ethylene and at least one kind of α-olefin having 3-20 carbon atoms, preferably one which is composed of ethylene and at least one kind of α-olefin having 3-12 carbon atoms. This copolymer effectively contributes to mechanical strength and modification.

Examples of α-olefin having 3-20 carbon atoms include propylene, 1-butene, 1-pentene, 1-hexene, 1-heptene, 1-otene, 1-nonene, 1-decene, 1-undecene, 1-dodecene, 1-tridecene, 1-tetradecene, 1pentadecene, 1-hexadecene, 1-heptadecene, 1-octadecene, 1-nonadecene, 1-eicosene, 3-methyl-1-butene, 3-methyl-1-pentene, 3-ethyl-1-pentene, 4-methyl-1-pentene, 4-methyl-1-hexene, 4,4-dimethyl-1-hexene, 4,4-dimethyl-1-pentene, 4-ethyl-1-hexene, 3-ethyl-1-hexene, 9-methyl-1-decene, 11-methyl-1-dodecene, and 12-ethyl-1-tetradecene. They may be used alone or in combination with one another.

The ethylene-α-olefin copolymer should be one which contains α-olefin comonomer in an amount of 1-30 mol %, preferably 2-25 mol %, more preferably 3-20 mol %. The copolymer may additionally contain at least one comonomer such as 1,4-hexadiene, dicyclopentadiene, 2,5-norbornadiene, 5-ethylidenenorbornane, 5-ethyl-2,5-norbornadiene, and 5-(1′-propenyl)-2-norbornene.

The copolymer of (ethylene and/or propylene) and (unsaturated carboxylic acid and/or unsaturated carboxylic ester) may contain as the unsaturated carboxylic acid either acrylic acid or methacrylic acid or a mixture thereof and also contain as the unsaturated carboxylic ester their methyl ester, ethyl ester, propyl ester, butyl ester, pentyl ester, hexyl ester, heptyl ester, octyl ester, nonyl ester, or decyl ester, or a mixture thereof. Preferable among these copolymers are ethylene-methacrylic acid copolymer and ethylene-methacrylic acid-acrylic ester copolymer.

As for the copolymer of (ethylene and/or propylene) and (unsaturated carboxylic acid and/or unsaturated carboxylic ester), with its carboxylic groups at least partly neutralized to form metal salt, the species of metal is not specifically restricted. Those metals that can be used are alkali metals (such as Li, Na, K, Mg, Ca, Sr and Ba) and alkali earth metals (such as Al, Sn, Sb, Ti, Mn, Fe, Ni, Cu, Zn, and Cd). Of these metals, Zn is most desirable.

The block copolymer of conjugated diene and vinyl aromatic hydrocarbon denotes any block copolymer elastomer of A-B type or A-B-A′ type, with the terminal blocks A and A′ being the same or different and the aromatic moiety being monocyclic or polycyclic. It is a thermoplastic homopolymer or copolymer derived from a vinyl aromatic hydrocarbon, which is exemplified by styrene, α methylstyrene, vinyltoluene, vinylxylene, ethylvinylxylene, and vinylnaphthalene, and mixture thereof. Block B is a polymer derived from a conjugated diene hydrocarbon which is exemplified by 1,3-butadiene, 2,3-dimethylbutadiene, isoprene, and 1,3-pentadiene, and a mixture thereof. Also, block B may be a hydrogenated one.

The polyolefin resin as component (B) in the present invention should preferably be a modified polyolefin resin which is obtained by modifying the above-mentioned polyolefin resin with at least one compound selected from unsaturated carboxylic acids and derivatives thereof. Such a modified polyolefin resin is characterized by its improved compatibility and ability to increase weld strength with a small amount added.

The modifier may be a derivative of unsaturated carboxylic acid in the form of metal salt, ester, imide, or acid anhydride.

Examples of the unsaturated carboxylic acid and derivative thereof are listed below.

Acrylic acid, methacrylic acid, maleic acid, fumaric acid, itaconic acid, crotonic acid, methylmaleic acid, methylfumaric acid, mesaconic acid, citraconic acid, and glutaconic acid, and metal salt thereof.

Methyl hydrogen maleate, methyl hydrogen itaconate, methyl acrylate, ethyl acrylate, butyl acrylate, 2-ethylhexyl acrylate, hydroxyethyl acrylate, methyl methacrylate, 2-ethylhexyl methacrylate, hydroxyethylmethacrylate, aminoethylmethacrylate, dimethyl maleate, and dimethyl itaconate.

Maleic anhydride, itaconic anhydride, citraconic anhydride, endobicyclo(2,2,1)-5-heptene-2,3-dicarboxylic acid, and endobicyclo-(2,2,1)-5-heptene-2,3-dicarboxylic anhydride.

Maleimide, N-ethylmaleimide, N-butylmaleimide, and N-phenylmaleimide.

Glycidyl acrylate, glycidyl methacrylate, glycidyl ethacrylate, glycidyl itaconate, and glycidyl citraconate.

5-norbornene-2,3-dicarboxylic acid.

Of these examples, unsaturated dicarboxylic acids and acid anhydrides thereof are suitable. Maleic acid and maleic anhydride are particularly suitable.

The functional group-containing component may be incorporated into the olefin compound in any manner which is not specifically restricted. One way is by copolymerization o- an olefin compound (as the major constituent) with a functional group-containing olefin compound. Another way is by the grafting of an unmodified polyolefin with a functional group-containing olefin compound with the aid of a radical initiator. The amount of the functional group-containing component should be 0.001-40 mol %, preferably 0.01-35mol %, of the total amount of olefinmonomer in the modified polyolefin.

The polyolefin resin as component (B) in the present invention may be produced in any manner which is not specifically restricted. It may be produced by radical polymerization, coordination polymerization with the aid of a Ziegler-Natta catalyst, anionic polymerization, or coordination polymerization with the aid of a metallocene catalyst.

The amount of polyolefin resin as component (B) for 100 parts by weight of the nylon resin as component (A) should be 0.1-50 parts by weight, preferably 0.1-30 parts by weight, and more preferably 0.5-30 parts by weight. With an amount less than 0.1 part by weight, the polyolefin resin does not contribute to improvement in weldability of the resin composition. With an amount more than 50 parts by weight, the polyolefin resin produces an adverse effect, such as decrease in flowability at the time of melt molding and decrease in heat resistance and mechanical strength.

The glass fiber as component (C) in the present invention may be one which is commonly used for resin reinforcement. It may be in the form of long fiber, short fiber (chopped strand), or milled fiber. The glass fiber is not specifically restricted in diameter. However, the fiber diameter usually ranges from 5 to 15 μm. The glass fiber may or may not be coated with or sized with ethylene-vinyl acetate copolymer or thermosetting resin. The glass fiber should preferably be coated with a surface treating agent such as silane coupling agent and titanate coupling agent. The amount of the glass fiber in the resin composition for 100 parts by weight of the nylon resins should be 10-150 parts by weight, preferably 20-80 parts by weight, and more preferably 20-60 parts by weight.

The copper compound as component (D) in the present invention includes, for example, cuprous chloride, cupric chloride, cuprous bromide, cupric bromide, cuprous iodide, cupric iodide, cupric sulfate, cupric nitrate, copperphosphate, cuprous acetate, cupric acetate, cupric salicylate, cupric stearate, and cupric benzoate. The inorganic copper halide mentioned above may form a complex compound with xylylene diamine, 2-mercaptobenzimidazole, benzimidazole, or the like. Of these examples, cuprous compounds are preferable, cuprous halides are more preferable, and cuprous acetate and cuprous iodide are most preferable.

The copper compound contributes to the strength of the weld zone when molded parts are joined together and the welded product undergoes annealing. The amount of the copper compound for 100 parts by weight of the nylon resin should be less than 3 parts by weight, for example 0.01-3 parts by weight, preferably 0.015-2 parts by weight, more preferably 0.02-2 parts by weight. With an amount less than 0.01 part by weight, the copper compound does not fully produce its effect. Conversely, with an amount more than 3 parts by weight, the copper compound liberates metallic copper at the time of melt molding, causing discoloration which degrades the product value.

According to the present invention, the copper compound may be used in combination with an alkali halide compound. Examples of the alkali halide compound include lithium chloride, lithium bromide, lithium iodide, potassium chloride, potassium bromide, potassium iodide, sodium bromide, and sodium iodide. Of these examples, potassium iodide and sodium iodide are particularly desirable. The amount of the alkali halide compound for 100 parts by weight of the nylon resin should be less than 5 parts by weight, for example, 0.01-5 parts by weight, preferably 0.05-3 parts by weight.

The silicone compound as component (E) in the present invention is an organosilicone compound whose skeleton is the siloxane linkage having organic groups attached directly to silicon atoms therein. Examples of the organic group include methyl group, ethyl group, phenyl group, vinyl group, and trifluoropropyl group. Any known silicone compounds may be used. Incidentally, the organic group may partly substituted with epoxy group, amino group, polyether group, carboxyl group, mercapto group, ester group, chloroalkyl group, hydroxyl group, or alkyl group having 3 or more carbon atoms.

Silicone compounds are classified into silicone oil, silicone elastomer, and silicone resin according to the degree of crosslinking. (See “Silicone Material Handbook” by Toray-Dow Corning Co., Ltd., August 1993.) Any of them may be used in the present invention.

Preferred examples of the silicone compounds include dimethyl silicone oil, phenylmethyl silicone oil, alkyl-modified silicone oil, fluorosilicone oil, polyether-modified silicone oil, aliphatic ester-modified silicone oil, amino-modified silicone oil, carboxylic acid-modified silicone oil, carbinol-modified silicone oil, epoxy-modified silicone oil, and mercapto-modified silicone oil. Additional examples include polyethylene glycol-modified silicone oil and polypropylene glycol-modified silicone oil, which contribute to weld strength. These silicone compounds may be used in combination with one another.

The amount of the silicone compound as component (E) for 100 parts by weigh of the nylon resin as component (A) should be less than 5 parts by weight, for example, 0.1-5 parts by weight, preferably 1-3 parts by weight.

The glass fiber specified above may be used in combination with other fibrous or non-fibrous inorganic fillers. Their examples are listed below.

Fibrous filler such as carbon fiber, potassium titanate whisker, zinc oxide whisker, aluminum borate whisker, aramid fiber, alumina fiber, silicon carbide fiber, ceramic fiber, asbestos fiber, gypsum fiber, and metal fiber.

Silicates such as wollastonite, zeolite, sericite, kaolin, mica, clay, pyrophyllite, bentonite, asbestos, talc, and alumina silicate.

Metal compounds such as alumina, silicon oxide, magnesium oxide, zirconium oxide, titanium oxide, and iron oxide.

Carbonates such as calcium carbonate, magnesium carbonate, and dolomite.

Sulfates such as calcium sulfate and barium sulfate.

Hydroxides such as magnesium hydroxide, calcium hydroxide, and aluminum hydroxide.

Non-fibrous fillers such as glass beads, ceramic beads, boron nitride, silicon carbide, and silica, which may be hollow.

They may be used in combination with one another. These fibrous or non-fibrous fillers may be pretreated with an isocyanate compound, organosilane compound, organotitanate compound, organoborane compound, or epoxy compound, so that they impart greater mechanical strength.

The nylon resin composition of the present invention may be incorporated with several additives as exemplified below.

Nucleating agent such as talk, kaolin, organic phosphorus compound, and polyether ether ketone.

Anti-coloring agent such as hypophosphite.

Antioxidant such as hindered phenol and hindered amine.

Slip agent such as polyalkylene glycol.

Heat stabilizer, UV light stabilizer, and coloring agent.

The nylon resin composition of the present invention may be prepared in any manner which is not specifically restricted. One efficient way is by melt-blending all the raw materials (such as nylon resin, polyolefin resin, and glass fiber, and optional copper compound and silicone compound) in a known melt blender (such as single- or twin-screw extruder, Banburymixer, kneader, and mixing roll) at a temperature, say 220-330° C., selected according to the melting point of the nylon resin. This method may be modifies such that the composition is prepared from all the raw materials except the polyolefin resin which (in the form of pellets) is added to the composition afterward.

In this way there is obtained the weldable resin composition of the present invention. It has a melt viscosity whose coefficient of shear rate dependence is higher than 1.05. Therefore, it exhibits outstanding weldability.

The coefficient of shear rate dependence is a value defined by [rate of increase in melt viscosity at a low shear rate] divided by [rate of increase in melt viscosity at a high shear rate]. [rate of increase in melt viscosity at a low shear rate] is a value defined by [melt viscosity of the weldable resin composition at a low shear rate] divided by [melt viscosity of the weldable resin composition excluding component (B) at a low shear rate]. [rate of increase in melt viscosity at a high shear rate] is a value defined by [melt viscosity of the weldable resin composition at a high shear rate] divided by [melt viscosity of the weldable resin composition excluding component (B) at a high shear rate]. The low shear rate is 60 sec⁻¹ and the high shear rate is 6000 sec⁻¹. The melt viscosity (in poise) is measured under the following conditions.

Equipment: Capillograph B1 made by Toyo Seiki

Temperature: 20° C. higher than the melting point of the nylon resin (in larger amount if two or more nylon resins are used).

Residence time: 5 minutes

Piston speed: 5 mm/min (for the shear rate of 60 sec⁻¹) or 500 mm/min (for the shear rate of 6000 sec⁻¹).

Incidentally, “the weldable resin composition excluding component (B)” denotes the resin composition which is composed of component (A) and component (C) and other optional components.

If the resin composition has a melt viscosity whose coefficient of shear rate dependence is high, it exhibits good flowability and hence good moldability at a high shear rate (which is normally encountered during injection molding) and it also increases in viscosity at a low shear rate (which is encountered during welding) and hence it exhibits high weld strength. Therefore, the resin composition should have a coefficient of shear rate dependence higher than 1.05, preferably higher than 1.08, more preferably higher than 1.10, so that it exhibits practically good weldability.

The weldable nylon resin composition of the present invention may be formed into weldable molded items by ordinary molding methods (such as injection molding, extrusion molding, and blow molding) under ordinary molding conditions. The weldable molded items can be joined together to form a molded product of desired shape. They may have ribs on their welding surface so as to facilitate vibration welding, ultrasonic welding, or microwave welding.

Welding of the weldable molded items may be accomplished in the following manner.

Vibration welding: Two molded items are held together vertically such that their mating surfaces are pressed against each other, and they are subjected to vibration in the horizontal direction so that frictional heat for welding is generated at the mating surfaces. The frequency of vibration is 100-300 Hz and the amplitude of vibration is 0.5-2.0 mm.

Injection welding: Molded items are inserted into a mold or moved in a mold, and the resin composition is injected into the space in which the joint is formed. The latter method is referred to as die slide molding or die rotating molding.

Ultrasonic welding: Two molded items are held together vertically such that their mating surfaces are pressed against each other, and they are subjected to ultrasonic vibration in the vertical direction so that frictional heat for welding is generated at the mating surfaces. The frequency of vibration is 100-300 Hz and the amplitude of vibration is 0.5-2.0 mm.

Microwave welding: Two molded items are held together such that their mating surfaces are pressed against each other, and they are subjected to high-frequency electric fields so that induction loss (due to friction among molecules) is produced and heat is generated for welding.

Using the welding method mentioned above, it is possible to produce welded products from the resin composition of the present invention. The resulting welded products are superior in weld strength, heat resistance, external appearance, dimensional stability, and weld uniformity. Stable, high weld strength is the main advantage. Owing to this advantage, the welded products will find use in the field of automotive parts, such as air intake manifold (for the intake system), water inlet and water outlet (for the cooling system), fuel injection and fuel delivery pipe (for the fuel system), and oil tank and other vessels.

### EXAMPLES

The invention will be described in more detail with reference to the following examples, which are not intended to restrict the scope thereof. In examples and comparative examples, amounts are expressed in terms of parts by weight.

Strength of material, flowability, and weld strength were measured by the methods explained below.

(1) Strength of material:

Tensile strength: according to ASTM D638

Flexural modulus: according to ASTM D790

(2) Flowability:

A sample of the material is injected into a mold for spiral flow measurement (10 mm wide, 2 mm thick, and 600 mm long) under the conditions specified below.

Injection temperature: 20° C. higher than the melting point of the nylon (in larger amount if two or more nylon resins are used).

Injection pressure: 30 kgf/cm²G

Mold temperature: 80° C.

Flowability is expressed in terms of the length of the distance over which the injected melt has flowed in the mold. The longer the distance, the better the flowability.

(3) Weld strength (in the case of vibration welding)

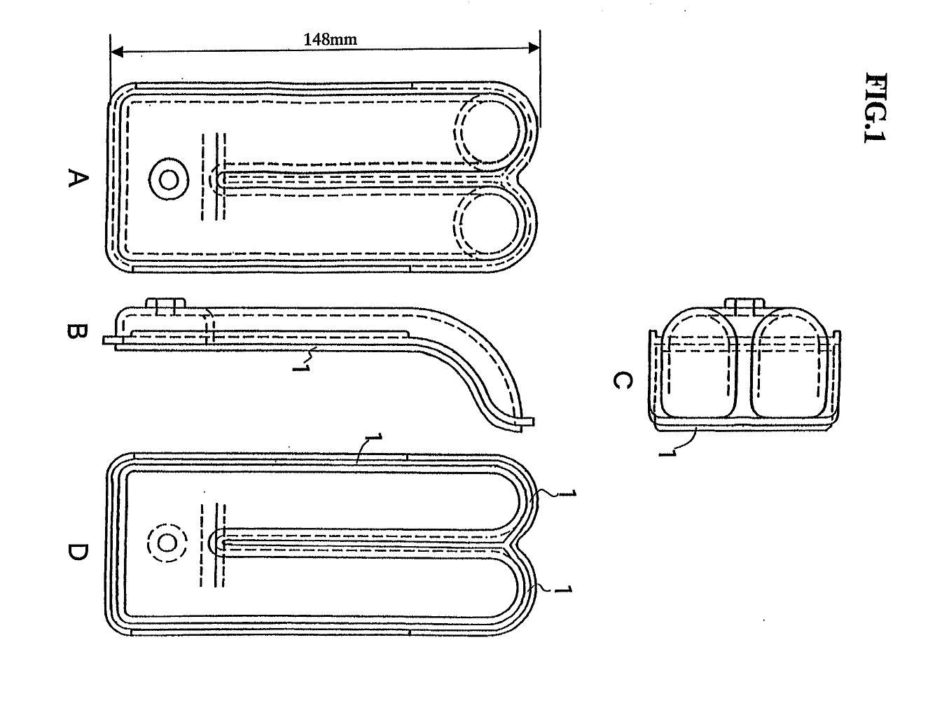

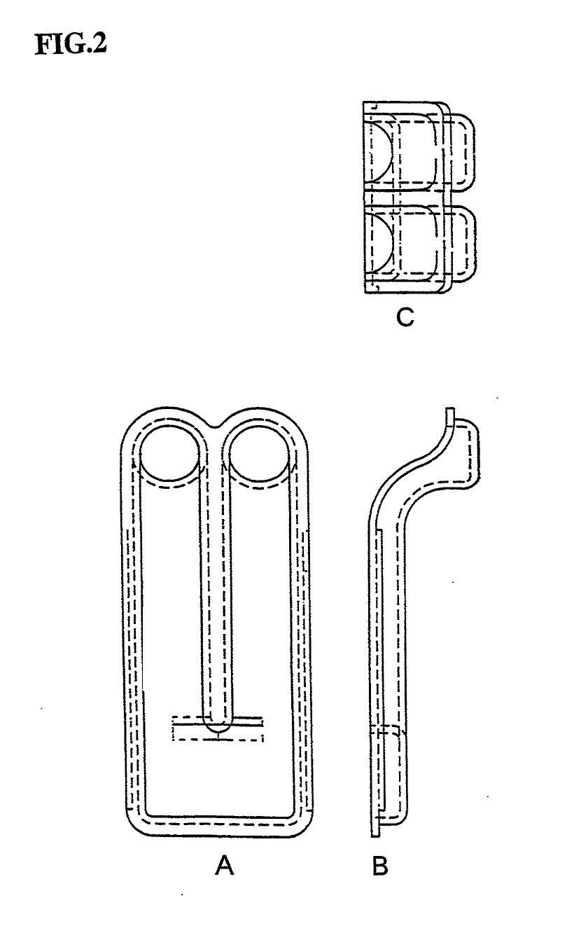

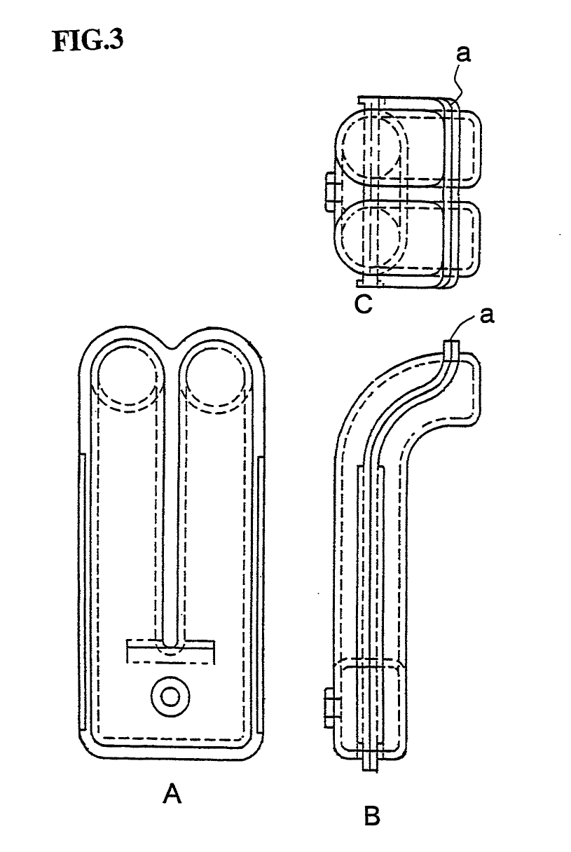

Two test pieces each having a 1.5-mm wide mating surface and 2.5-mm high bead 1 are injection-molded under ordinary conditions as shown in FIGS. 1 and 2. They are joined together by vibration welding under the following conditions by using a vibration welding machine, Model 2850, made by Branson Co., Ltd. Frictional heat generated by vibration melts the bead, thereby giving a welded hollow product as shown in FIG. 3.

Clamp Pressure: 100 kgf

Frequency: 240 Hz

Amplitude: 1.5 mm

Melt down: 1.5 mm

The welded hollow product thus obtained is filled with water and subjected to internal pressure in a water tank. The pressure to bring about burst is regarded as weld strength.

The welded hollow product is kept at 150° C. for 10 hours in a heating oven and then measured for weld strength in the same way as mentioned above. The retention of weld strength is calculated.

(4) Weld strength (in the case of injection welding)

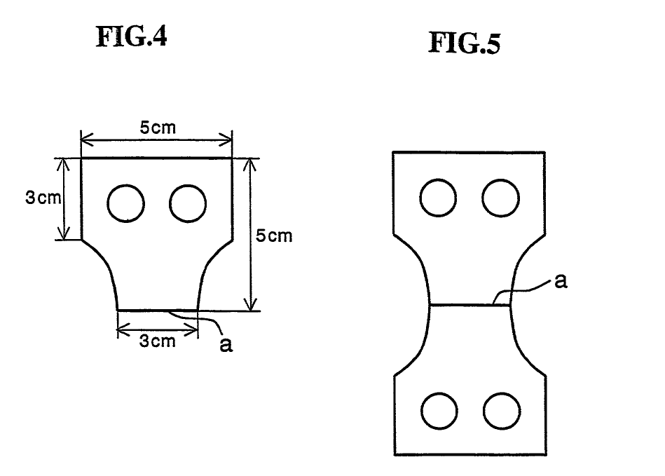

Two test pieces (10 mm thick) are injection-molded under ordinary conditions as shown in FIG. 4. They are inserted into a mold for fatigue test samples and joined together by injection welding in such a way that the side a constitutes the weld zone. The welded product thus obtained is subjected to tensile test (at a pulling rate of 5 mm/sec and a span of 50 mm). The force required to break the weld zone (a) is regarded as weld strength.

The nylon resin and polyolefin resin used in Examples and Comparative Examples are specified below.

Nylon Resin

N6: nylon 6 resin having a melting point of 225° C. and a relative viscosity of 2.70.

N6/66: nylon 6/66 copolymer (97/3 in molar ratio) having a melting point of 217° C. and a relative viscosity of 2.65.

N66: nylon 66 resin having a melting point of 265° C. and a relative viscosity of 2.90.

N610: nylon 610 resin having a melting point of 225° C. and a relative viscosity of 2.70.

6T/12: nylon 6T/12 copolymer (60/40 in molar ratio) having a melting point of 300° C. and a relative viscosity of 2.50.

Polyolefin Resin

B-1: polypropylene (MER=1.5)

B-2: modified polypropylene obtained from 100 parts by weight of B-1, 1 part by weight of maleic anhydride, and 0.1 part by weight of 2,5-dimethyl-2,5-di (tert-butylperoxy) hexane by melt extrusion through a twin-screw extruder at a cylinder temperature of 220° C.

B-3: ionomer of ethylene-methacrylic acid copolymer, with its carboxylic acid moiety partly forming zinc salt.

B-4: modified ethylene-1-butene copolymer obtained from 100 parts by weight of ethylene-1-butene copolymer, 1 part by weight of maleic anhydride, and 0.1 part by weight of 2,5-dimethyl-2,5-di(tert-butylperoxy)hexane by melt extrusion through a twin-screw extruder at a cylinder temperature of 230° C.

B-5: modified low-density polyethylene obtained from 100 parts by weight of low-density polyethylene (having a density of 0.905, produced with the aid of metallocene catalyst), 1 part by weight of maleic anhydride, and 0.1 parts by weight of 2,5-dimethyl-2,5-di(tert-butylperoxy)hexane by melt extrusion through a twin-screw extruder at a cylinder temperature of 230° C.

### Examples 1 to 16 and Comparative Examples 1 to 4

Several compositions were made from nylon resin, polyolefin resin, glass fiber (13 μm in diameter), and copper compound according to the formulation shown in Tables 1 to 5. Each composition was pelletized by melt blending through a twin-screw extruder (Model TEX30, made by The Japan Steel Works, Ltd.) at a cylinder temperature of 250-280° C. and a screw speed of 150 rpm. The resulting pellets were dried and then injection molded (at a mold temperature of 80° C.) into various test pieces. The pellet samples and test pieces were measured for melt viscosity, flowability, and strength. Hollow products were formed from test pieces by vibration welding, and they were tested for weld strength. The results are shown in Tables 1 to 5.

Incidentally, in Comparative Example 2, MAH-PPE denotes polyphenylene ether resin modified with maleic anhydride. The compound used as the heat resistant material is CuI (cuprous iodide) or KI (potassium iodide). The silicone compound is polypropylene glycol-modified silicone oil.

Examples 1 to 16 demonstrate that the weldable resin composition of the present invention has good flowability and material strength, which are balanced well with each other, and a melt viscosity whose coefficient of shear rate dependence is high. The resin composition gave, by vibration welding, hollow products having high weld strength.

In contrast, the resin compositions in Comparative Examples 1 to 4, which were not incorporated with a polyolefin resin, gave hollow products which are poor in weld strength and strength retention after annealing.

TABLE 1

| | Item | Unit | Example 1 | Example 2 | Example 3 | Example 4 | Example 5 |
|---|---|---|---|---|---|---|---|
| Formulation | Nylon resin (a) | — | N6 | N6 | N6 | N6 | N6 |
| | Amount | pbw | 100 | 100 | 100 | 100 | 100 |
| | Polyolefin resin | — | B-1 | B-2 | B-3 | B-4 | B-5 |
| | Amount | pbw | 5 | 5 | 5 | 5 | 5 |
| | Amount of glass fiber | pbw | 45 | 45 | 45 | 45 | 45 |
| Flowability | Length of flow | mm | 150 | 145 | 150 | 145 | 148 |
| Material | Tensile strength | MPa | 160 | 165 | 170 | 165 | 165 |
| strength | Flexural modulus | GPa | 8.2 | 8.2 | 8.0 | 7.8 | 8.0 |
| Melt viscosity | at low shear rate | poise | 12520 | 13700 | 12600 | 14910 | 14600 |
| | at high shear rate | poise | 1710 | 1820 | 1700 | 1860 | 1790 |
| | Coefficient of shear rate dependence | — | 1.05 | 1.08 | 1.06 | 1.15 | 1.17 |
| Weldability | Strength of vibration welding | kgf/cm² | 11.2 | 11.9 | 12.5 | 13.8 | 13.9 |
| | After annealing (150° C., 10 h) | kgf/cm² | 9.7 | 10.5 | 11.0 | 12.0 | 12.2 |
| | Retention of strength | % | 87 | 87 | 88 | 87 | 88 |

TABLE 2

| | Item | Unit | Example 6 | Example 7 | Example 8 | Example 9 | Example 10 |
|---|---|---|---|---|---|---|---|
| Formulation | Nylon resin (a) | — | N6 | N6 | N6 | N6 | N6 |
| | Amount | pbw | 100 | 100 | 100 | 100 | 100 |
| | Polyolefin resin | — | B-2 | B-4 | B-5 | B-4 | B-4 |
| | Amount | pbw | 2 | 10 | 10 | 15 | 5 |
| | Amount of glass fiber | pbw | 45 | 45 | 45 | 50 | 45 |
| | Copper compound | — | | Cul/Kl | Cul/Kl | Cul/Kl | Cul/Kl |
| | Amount | pbw | — | 0.04/0.35 | 0.04/0.35 | 0.04/0.35 | 0.04/0.35 |
| | Silicone compound | — | | | | | |
| | Amount | pbw | — | — | — | — | 1 |
| Flowability | Length of flow | mm | 147 | 140 | 140 | 137 | 150 |
| Material | Tensile strength | MPa | 170 | 165 | 165 | 160 | 165 |
| strength | Flexural modulus | GPa | 8.0 | 7.5 | 7.5 | 7.0 | 7.7 |
| Melt viscosity | at low shear rate | poise | 12000 | 15890 | 16120 | 17560 | 14800 |
| | at high shear rate | poise | 1690 | 1900 | 1850 | 2000 | 1800 |
| | Coefficient of shear rate dependence | — | 1.02 | 1.20 | 1.25 | 1.26 | 1.18 |
| Weldability | Strength of vibration welding | kgf/cm² | 10.0 | 14.4 | 14.5 | 15.0 | 14.8 |
| | After annealing (150° C., 10 h) | kgf/cm² | 8.8 | 14.2 | 14.4 | 14.7 | 14.6 |
| | Retention of strength | % | 88 | 99 | 99 | 98 | 99 |

TABLE 3

| | Item | Unit | Example 11 | Example 12 | Example 13 | Example 14 |
|---|---|---|---|---|---|---|
| Formulation | Nylon resin (a) | — | N66 | N66 | N66 | N6/66 |
| | Amount | pbw | 100 | 100 | 100 | 100 |
| | Polyolefin resin | — | B-4 | B-5 | B-4 | B-4 |
| | Amount | pbw | 5 | 10 | 15 | 5 |
| | Amount of glass fiber | pbw | 45 | 45 | 50 | 45 |
| | Copper compound | — | Cul/Kl | Cul/Kl | Cul/Kl | Cul/Kl |
| | Amount | pbw | 0.04/0.35 | 0.04/0.35 | 0.04/0.35 | 0.04/0.35 |
| Flowability | Length of flow | mm | 150 | 150 | 145 | 145 |
| Material | Tensile strength | MPa | 180 | 180 | 174 | 155 |
| strength | Flexural modulus | GPa | 8.3 | 8.0 | 7.8 | 7.3 |
| Melt viscosity | at low shear rate | poise | 9300 | 9300 | 11050 | 11200 |
| | at high shear rate | poise | 1130 | 1100 | 1240 | 1300 |
| | Coefficient of shear rate dependence | — | 1.09 | 1.12 | 1.18 | 1.11 |
| Weldability | Strength of vibration welding | kgf/cm² | 10.0 | 11.3 | 12.1 | 13.4 |
| | After annealing (150° C., 10 h) | kgf/cm² | 10.0 | 11.2 | 11.8 | 13.4 |
| | Retention of strength | % | 100 | 99 | 98 | 100 |

TABLE 4

| | | | Example | Example |
|---|---|---|---|---|
| | Item | Unit | 15 | 16 |
| Formulation | Nylon resin (a) | — | N6 | N66 |
| | Amount | pbw | 70 | 80 |
| | Nylon resin (b) | — | N610 | 6T/12 |
| | Amount | pbw | 30 | 20 |
| | Polyolefin resin | — | B-4 | B-4 |
| | Amount | pbw | 5 | 5 |
| | Amount of glass fiber | pbw | 45 | 45 |
| | Copper compound | — | Cul/Kl | Cul/Kl |
| | Amount | pbw | 0.04/0.35 | 0.0.4/0.35 |
| Flowability | Length of flow | mm | 150 | 140 |
| Material | Tensile strength | MPa | 160 | 175 |
| stength | Flexural modulus | GPa | 7.2 | 8.5 |
| Melt | at low shear rate | poise | 13050 | 13780 |
| viscosity | at high shear rate | poise | 1600 | 1460 |
| | Coefficient of shear | — | 1.17 | 1.25 |
| | rate dependence | | | |
| Weldability | Strength of vibration | kgf/cm² | 14.0 | 13.2 |
| | welding | | | |
| | After annealing (150° C., | kgf/cm² | 13.8 | 13.0 |
| | 10 h) | | | |
| | Retention of strength | % | 99 | 98 |

TABLE 5

| | | | Comparative | Comparative | Comparative | Comparative |
|---|---|---|---|---|---|---|
| | Item | Unit | Example 1 | Example 2 | Example 3 | Example 4 |
| Formulation | Nylon resin (a) | — | N6 | N6 | N66 | N6/66 |
| | Amount | pbw | 100 | 100 | 100 | 100 |
| | Other resin | — | — | MAH-PPE | — | — |
| | Amount | pbw | | 10 | | |
| | Amount of glass fiber | pbw | 45 | 45 | 45 | 45 |
| Flowability | Length of flow | mm | 150 | 138 | 155 | 150 |
| Material strength | Tensile strength | MPa | 170 | 165 | 180 | 158 |
| | Flexural modulus | GPa | 8.2 | 8.2 | 8.5 | 7.5 |
| Melt viscosity | at low shear rate | poise | 11430 | 15430 | 7550 | 8930 |
| | at high shear rate | poise | 1640 | 2150 | 1000 | 1150 |
| | Coefficient of shear rate dependence | — | — | 1.03 | — | — |
| Weldability | Strength of vibration welding | kgf/cm² | 9.0 | 8.5 | 7.5 | 9.4 |
| | After annealing (150° C., 10 h) | kgf/cm² | 7.8 | 7.6 | 6.0 | 7.7 |
| | Retention of strength | % | 87 | 89 | 80 | 82 |

### Examples 17 and 18 and Comparative Examples 5 and 6

The same procedure as in Examples 1 to 16 was repeated except that the formulation was changed as shown in Table 6 and vibration welding was replaced by injection welding. The results are shown in Table 6. Incidentally, in Comparative Example 6, MAH-PPE denotes polyphenylene ether resin modified with maleic anhydride.

Examples 17 and 18 demonstrate that the weldable resin composition of the present invention has good flowability and material strength, which are balanced well with each other, and a melt viscosity whose coefficient of shear rate dependence is high. The resin composition gave, by injection welding, hollow products having high weld strength.

In contrast, the resin compositions in Comparative Examples 5 to 6, which were not incorporated with a polyolefin resin, gave hollow products which are poor in weld strength.

TABLE 6

| | | | | | Comparative | Comparative |
|---|---|---|---|---|---|---|
| | Item | Unit | Example 17 | Example 18 | Example 5 | Example 6 |
| Formulation | Nylon resin (a) | — | N6 | N6 | N6 | N6 |
| | Amount | pbw | 100 | 100 | 100 | 100 |
| | Polyolefin resin | | B-4 | B-5 | — | — |
| | Amount | pwb | 5 | 5 | | |
| | Other resin | — | — | — | — | MAH-PPE |
| | Amount | pbw | | | | 5 |
| | Amount of glass fiber | pbw | 45 | 45 | 45 | 45 |
| Flowability | Length of flow | mm | 145 | 148 | 150 | 138 |
| Material strength | Tensile strength | MPa | 165 | 165 | 170 | 165 |
| | Flexural modulus | GPa | 7.8 | 8.0 | 8.2 | 8.2 |
| Melt viscosity | at low shear rate | poise | 14910 | 14600 | 11430 | 15430 |
| | at high shear rate | poise | 1860 | 1790 | 1640 | 2150 |
| | Coefficient of sheer rate dependence | — | 1.15 | 1.17 | — | 1.03 |
| Weldability | Strength of injection welding | MPa | 73 | 75 | 66 | 68 |

What is claimed is:

1. A weldable resin composition which comprises 100 parts by weight of nylon resin as component (A), 0.1-50 parts by weigh of polyolefin resin as component (B), and 10-150 parts by weight of glass fiber as component (C) blended together.

2. A weldable resin composition as defined in claim 1, which is capable of vibration welding, injection welding, ultrasonic welding, or microwave welding.

3. A weldable resin composition as defined in claim 1, which is capable of vibration welding.

4. A weldable resin composition as defined in any of claims 1 to 3, which has a melt viscosity whose coefficient of shear rate dependence is higher than 1.05,
Coefficient of shear rate dependence= Rate of increase in melt viscosity at a low shear rate/Rate of increase in melt viscosity at a high shear rate,
Rate of increase in melt viscosity at a low shear rate= Melt viscosity of the weldable resin composition at a low shear rate/Melt viscosity of the weldable resin composition excluding component (B) at a low shear rate,
Rate of increase in melt viscosity at a high shear rate= Melt viscosity of the weldable resin composition at a high shear rate/Melt viscosity of the weldable resin composition excluding component (B) at a high shear rate,
wherein the low shear rate is 60 sec⁻¹ and the high shear rate is 6000 sec⁻¹.

5. A weldable resin composition as defined in any of claims 1 to 4, wherein the polyolefin resin as component (B) is at least one species selected from polyethylene, polypropylene, polyacrylic ester, polymethacrylic ester, ethylene-α-olefin copolymer, copolymer of (ethylene and/or propylene) and (unsaturated carboxylic acid and/or unsaturated carboxylic ester) with its carboxylic acid partly neutralized to form metal salt, block copolymer of conjugated diene and vinyl aromatic hydrocarbon, and hydrogenated product of said block copolymer.

6. A weldable resin composition as defined in any of claims 1 to 4, wherein the polyolefin resin as component (B) is polyethylene and/or ethylene-α-olefin copolymer.

7. A weldable resin composition as defined in claim 6, wherein the ethylene-α-olefin copolymer is one in which the αolefin moiety is at least one species selected from α-olefins having 3-20 carbon atoms and the amount of the comonomer is 1-30 mol %.

8. A weldable resin composition as defined in any of claims 1 to 7, wherein the polyolefin resin as component (B) is a modified polyolefin resin in which the modifier is at least one compound selected from unsaturated carboxylic acids and derivatives thereof.

9. A weldable resin composition as defined in claim 8, wherein the modified polyolefin is one in which the modifier is at least one compound selected from unsaturated carboxylic acids, metal salts thereof, esters thereof, amides thereof, and acid anhydrides thereof.

10. A weldable resin composition as defined in any of claims 1 to 9, which further comprises 0.01-3 parts by weight of copper compound as component (D) for 100 parts by weight of nylon resin.

11. A weldable resin composition as defined in claim 10, wherein the copper compound is a cuprous compound.

12. A weldable resin composition as defined in claim 11, wherein the cuprous compound is cuprous halide.

13. A weldable resin composition as defined in any of claims 1 to 12, which further comprises 0.1-5 parts by weight of silicone compound as component (E) for 100 parts by weight of nylon resin.

14. A weldable resin composition as defined in any of claims 1 to 13, wherein the nylon resin is at least one species selected from nylon 66, nylon 6, and copolymers composed mainly of them.

15. A weldable resin composition as defined in claim 14, wherein the nylon resin as component (A) is composed of (a) 99-50 wt % of at least one species selected from nylon 66, nylon 6, and copolymers composed mainly of them and (b) 1-50 wt % of at least one species selected from nylon resins other than (a) defined above.

16. A method of producing a weldable resin composition, said method comprising melt-blending 100 parts by weight of nylon resin as component (A), 0.1-50 parts by weight of polyolefin resin as component (B), 10-150 parts by weight of glass fiber as component (C), 0-3 parts by weight of copper compound as component (D), and 0-5 parts by weight of silicone compound as component (E), or said method comprising melt-blending 100 parts by weight of nylon resin as component (A), 10-150 parts by weight of glass fiber as component (C), 0-3 parts by weight of copper compound as component (D), and 0-5 parts by weight of silicone compound as component (E), and then melt-blending the resulting composition with 0.1-50 parts by weight of polyolefin resin as component (B).

17. A molded product produced from the weldable resin composition defined in any of claims 1 to 15.

18. A method of producing a molded product by welding two or more molded items formed from the weldable resin composition defined in any of claims 1 to 15.

19. A method of producing a molded product as defined in claim 18, wherein the molded product is hollow.

20. A molded product produced by the method defined in claim 18 or 19.
